(19) United States
(12) Patent Application Publication
(10) Pub. No.: US 2015/0213091 A1
(43) Pub. Date: Jul. 30, 2015

(54) SOCIAL MATCHING AND INTERACTION

(71) Applicant: Revealr Software Limited, London (GB)

(72) Inventors: Paul Laight, London (GB); Guy Harrington, London (GB)

(73) Assignee: Revealr Software Limited, London (GB)

(21) Appl. No.: 14/242,578

(22) Filed: Apr. 1, 2014

(30) Foreign Application Priority Data
Jan. 29, 2014 (GB) 1401528.3

(51) Int. Cl. G06F 17/30; H04L 12/58

(52) U.S. Cl. CPC G06F 17/30477; H04L 51/32

(57) ABSTRACT

A method for facilitating location based social interaction is described. The method comprises the steps of: requesting a search criteria based on a primary user profile of a primary user; searching for N secondary users conforming to the search criteria; and transmitting secondary user profiles of the N secondary users to a primary user device. Additionally, each secondary user profile contains personalised audio information relevant to the secondary user. This allows for social matching and interaction based on audio information, which tends to lead to a more considered decision by users.

### CROSS-REFERENCE TO RELATED APPLICATION(S) AND CLAIM OF PRIORITY

The present application claims priority to GB 1401528.3, filed Jan. 29, 2014 entitled “SOCIAL MATCHING AND INTERACTION”. The content of the above-identified patent document is incorporated herein by reference.

### TECHNICAL FIELD

The present disclosure relates to methods for facilitating location based social matching and interaction. More particularly, the present disclosure describes methods and systems for facilitating location based social interaction using profile information containing audio information.

### BACKGROUND OF THE DISCLOSURE

Social media such as Facebook™, Twiter™, Google+™ and other social networks have facilitated an increased ability for individuals to interact using the internet. As well as being used to provide social updates, blogging features and sharing personal information, recent applications have begun to harness the data collected and stored within social media. One such application is to facilitate the creation of relationships and links between users for the purposes of networking or dating.

U.S. Pat. No. 8,606,297 describes one such application that provides interaction amongst users of a web or other site to exchange information. In particular methods and apparatus for providing location based display of images and other information including from other users is described.

One disadvantage of the prior art described above is a lack of privacy and the potential for indiscriminate and unwanted messages and requests for interaction. Tinder™ provides location information and also harvests user information from available social media sites, such as Facebook™ and presents a selection of visual information, such as an image of the profile owner to other users of a dedicated application. Users of the application can choose to accepts, agrees or ‘like’ a person whose information is displayed within the application. If a ‘liked’ person also likes the first profile owner, a match is indicated and additional user information is released by the application, including the ability to converse via instant messaging within the application.

As noted above, Tinder relies on visual information presented to a user to provide an incentive for other users to like and initiate interaction with the profile owner. However, the propensity for profile owners to display fake or misleading visual information and images is high. Additionally, the visually impaired cannot use the application to its full potential.

### SUMMARY OF THE DISCLOSURE

It is an aim of embodiments of the present disclosure to alleviate the above mentioned problems.

According to a first aspect of the present disclosure, there is provided a method for facilitating location based social interaction, said method comprising the steps of: requesting a search criteria based on a primary user profile of a primary user; searching for N secondary users conforming to the search criteria; and transmitting secondary user profiles of the N secondary users to a primary user device; wherein each secondary user profile contains personalised audio information relevant to the secondary user.

It can be appreciated that providing personalised audio information relevant to the secondary user can allow the secondary user to appear to be more genuine and personable than using visual information. The use of visual information tends produce a reaction based on an initial instinctive consideration, whereas a decision based on audio information tends to be more considered. Additionally, audio information is typically more difficult to fake than images. Verification of audio information against existing audio information held against other secondary users and/or other audio information stored in a database may also be undertaken. This assists in preventing fraudulent audio information from being used.

Embodiments can further comprise the step of: obtaining a location for the primary user of the primary user device. Additionally, the N secondary users may be selected based at least on the range of the secondary user from the primary user. This allows only secondary users located close to the primary user to be identified, which is desirable when seeking certain types of connections via social media. The distance or range may be selected based on the users current or last known location or it may be based on a location set by the primary or secondary user. The location may be determined using Geohashing techniques and applying a Haversine function to determine a location range for secondary users via their respective Geohashes.

The N secondary users may be selected based on the search criteria of the primary user and the search criteria of the secondary user. This allows the secondary users to be ranked to increase the chance that a primary user is likely to like the selected secondary user. For example, the application may only select and display secondary users with a specific hobby or interest in common with the primary user.

The search criteria may comprise analysing one or more search flags, said search flags including one or more of whether: the secondary user profile has been previously viewed by the primary user; ranking flags are activated in the secondary/primary user profile; there is overlapping preference information in the secondary user profile and the primary user profile; the ages of the secondary and primary users are within identified ranges; the primary user profile has previously been viewed by the secondary user; the secondary users profile is active; the gender of the secondary user matches a gender that the primary user has selected; and the secondary user is interested in the selected gender of the primary user. This again allows a degree of sifting and selection based on the interests and likes of the primary user.

Preferably, the ranking flags include a preferential ranking flag. In certain configurations, the search flags identifying whether the secondary user profile has previously been viewed by the primary user can be overridden by a reset flag stored on the primary user profile; or the search flags identifying whether the secondary user profile has previously been viewed by the primary user can be overridden by a reset flag stored on the secondary user profile. Such flags can be used to allow a primary or secondary user to view or be viewed by a user who has previously dismissed them. As such it acts as a second chance to create a connection with the primary or secondary user.

The reset flag may be a variable stored in the primary user profile or may be a variable stored in the secondary user profile.

Preferably the secondary user profiles contain pixelated visual information. The visual information can be pixelated on the primary user device and may be a picture or a video or both. In certain configurations, the visual information can be selectively pixelated, wherein parts of the visual information are not pixelated. By pixelating any visual information, it is ensured that any decisions made by the primary user as to whether or not they like the selected secondary user are based on the audio information and/or user profile information rather than visual information such as videos or images. In particular, this is of benefit to visually handicapped users and also allows for a greater degree of security for the primary user because audio information is generally more difficult to falsify. Selectively pixelating allows a user to present a particularly important piece of visual information to the primary user. This may increase the likelihood that the primary user reacts favourably to the secondary user.

According to a second aspect of the present disclosure there is provided a system for generating a social match between individuals based on non-visual information; said system comprising: a primary user device capable of receiving and transmitting information and containing a primary profile of a primary user containing stored search preference information; a database capable of receiving information from, and transmitting information to, the primary user device and containing secondary user profiles of one or more secondary users, said secondary user profiles each containing secondary audio information relevant to each secondary user; and wherein the database is configured to receive the primary profile from the primary user device, sort or sift the secondary user profiles based on the search preference information and to transmit one or more secondary user profiles to the primary user.

The system may further comprise: a user interface on the primary user device allowing the primary user to indicate a positive or negative response to the second audio information contained in the one or more secondary user profiles, wherein the primary user device is configured to transmit the positive or negative responses to the database and wherein the database is configured to receive and store the positive or negative profile response of the primary user against each respective secondary user profile. Requiring a positive or negative response based on audio information contained in the one or more secondary user profiles ensures that any positive response is not based on visual information at all or alone. This tends to lead to a more reasoned and considered response than one based at least in part on visual information. Verification of audio information against existing audio information held against other secondary users and/or other audio information stored in a database may also be undertaken. This assists in preventing fraudulent audio information from being used.

According to a third aspect of the present disclosure, there is provided a method comprising the step of providing a system according to the second aspect.

In certain configurations, when a positive profile response is received and stored, the method further includes the steps of querying the database to determine if a mutual match exists. Mutual matches ensure that both the primary user and the secondary user are likely to respond positively to each other in further social interactions.

In an embodiment, a mutual match can exist if the primary user has indicated a positive profile response to the secondary user and the secondary user has indicated a positive profile response to the primary user.

Further examples can include wherein the step of querying the database to determine if a mutual match exists includes searching the database for profile responses of the selected secondary user to determine whether a stored profile response is assigned with the primary user and if a stored profile response is present.

Preferably, if the stored profile response of the secondary user and the stored profile response of the primary user are both positive, a mutual match is indicated to the primary user. In certain configurations, the mutual match can also indicated to the secondary user.

In embodiments, if a negative profile response is obtained, the selected secondary user is removed from a local pool of users and an alternative secondary user is presented to the primary user. Additionally, if a mutual match is not present, the positive query response is stored in the database and aligned against the selected secondary user. Within the local pool of secondary users the secondary users may be ranked according to the ranking preference information. The method can also use a profile cache, which caches a number of secondary user profiles for display to the primary user to enable a smooth and fast experience for the primary user.

Additionally, if the stored profile response of the selected secondary user is positive the method may further comprise the step of relaying this information to the primary user.

In preferred embodiments, the step of searching for one or more secondary users preferably includes the steps of: querying a user database to establish a local pool of users; sifting the local pool of users based on at least one of the search preference information and additional primary user information.

Typically, if a negative profile response is obtained, this information is relayed to the user. This allows the user to choose to reinstate the selected secondary user to the local pool of users.

Typically, the primary and secondary profiles contain pixelated visual information. Presenting a pixelated version of visual information to the primary user can act to reassure the primary user that the secondary user is genuine. Additionally, providing pixelated visual information makes the app more appealing to use.

Furthermore, when a mutual match exists, the secondary profile can be displayed to the primary user. An unpixelated version of the visual information can be presented to the secondary user and primary user respectively in the event that a mutual match is generated.

It is preferable that the search preference information comprises one or more of: secondary user age; secondary user activity; and secondary user gender.

Selecting a secondary user may includes the steps of: downloading a local pool of users containing one or more secondary user profiles to an electronic device associated with the primary user; and storing the one or more secondary user profiles to the electronic device.

According to a fourth aspect of the present disclosure, there is provided a computer program product for facilitating location based social matching, the computer program product comprising a non-transitory computer-readable medium including codes for causing the computer to perform the method according to any embodiments of the first and third aspects.

According to a fifth aspect of the present disclosure, there is provided a server system for handling location based social matching, the server system comprising: a processor; and processor readable memory; and a database comprising: a plurality of profiles associated with a of plurality of users, including audio information assigned and distinguishing each user; location indicators associated with each profile; and cross-referenced profile responses between the plurality of users.

Whilst the number of profiles is generally equal to the number of users, alternatives may allow premium users to have more than one profile associated with that secondary user. This allows the premium user to tailor profiles to target primary users with different search criteria. Additionally, it may be possible to have less profiles than the number of secondary users if secondary users are allowed to be entered onto the database without submitting profile information. In this case, the primary user may be able to sift out such secondary users.

Certain embodiments of the present disclosure provide a proximity-based social network service and notification system on mobile devices in which registered users are notified of mutual interest formed from their stored voice profile, pixelated profile image/video and GPS Location. Users are presented a self recorded voice/video profile, pixelated profile image/video, first name and age of another potential match based off their proximity from a GPS Location, the user can then either approve interest in the user or decline the user. Once such selection is accomplished, the user is notified if the selection is mutual by confirming they have been matched. The users are then able to converse through the chat function.

Preferably the method can additionally include the step of after analysing the profiles of the secondary users, ranking the profiles according to a predetermined ranking criteria. The predetermined ranking criteria can be based on one or more of: whether the secondary user profile has been previously viewed by the primary user; ranking flags activated in the secondary user profile; distance between the secondary user and the primary user; and overlapping preference information in the secondary user profile and the primary user profile.

In addition to the above, ranking flags may be activated in the secondary user profile. Such ranking flags allow secondary users to discriminate themselves from other secondary users. One such ranking flag may include a preferential ranking flag. Such preferential ranking flag may allow, for example, the secondary user to override the search criteria of the primary user to allow the secondary user to be artificially placed at the top of the ranking of secondary users. Additionally, or alternatively, the preferential ranking flag may allow a secondary user to be presented to a primary user even if the secondary user is outside of the predetermined distance cutoff from the primary user.

In embodiments, the search criteria may includes social preferences. These can include hobbies, interests and other relevant social information to assist in facilitating ranking and matching.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic representation of an information input screen which may be provided on a users device according to aspects of the present disclosure;

FIG. 2 is further input screen allowing the selection of profile relevant information;

FIG. 3 is a screen representing a secondary profile as presented to a primary user;

FIG. 4a is a match screen providing secondary profile information to a primary user;

FIG. 5 is a messages menu screen according to an embodiment of the present disclosure;

FIG. 6 is an individual message screen showing messages between a primary user and a secondary user;

FIG. 7 is a menu screen providing display options for the primary user;

FIG. 8 is a likes screen providing a summary of mutual matches to the primary user;

FIG. 9 is a second chance screen outlining an embodiment of the present disclosure;

FIG. 10 is a flowchart outlining a method according to aspects of the present disclosure;

FIG. 11 is a Single GeoHash map at precision p;

FIG. 12 is a Geohash grid centered around an primary users Geohash;

FIG. 13 is a GeoHash grid increased by one level to capture additional secondary profiles;

FIG. 14 is an array after it has been populated from the Geohash search;

FIG. 15 is an array after the sort has placed the secondary users who like the primary user at the top;

FIG. 16 is an array after a sort for the “Likes You” column based on ascending distance; and

FIG. 17 is an array after a sort for the “Likes You” column based on ascending distance.

### DETAILED DESCRIPTION

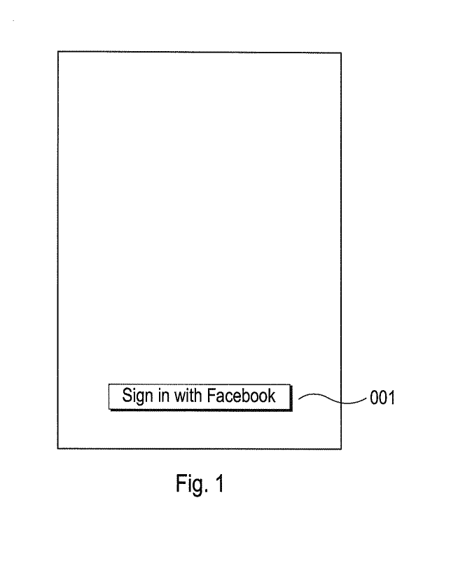

FIGS. 1 through 17, described below, and the various embodiments used to describe the principles of the present disclosure in this patent document are by way of illustration only and should not be construed in any way to limit the scope of the disclosure. Those skilled in the art will understand that the principles of the present disclosure may be implemented in any type of suitably arranged device or system.

FIG. 1 shows a schematic representation of an information input screen rendered by a user device upon launching of a social interaction application executed on the device. The user device may be any suitable electronic device containing a processor that is intended to be used and interacted with by a user. Examples include smartphone devices, typically those with a touchscreen interface, tablet devices, computers, interactive televisions, ‘smart’ wearable technology such as watches etc.

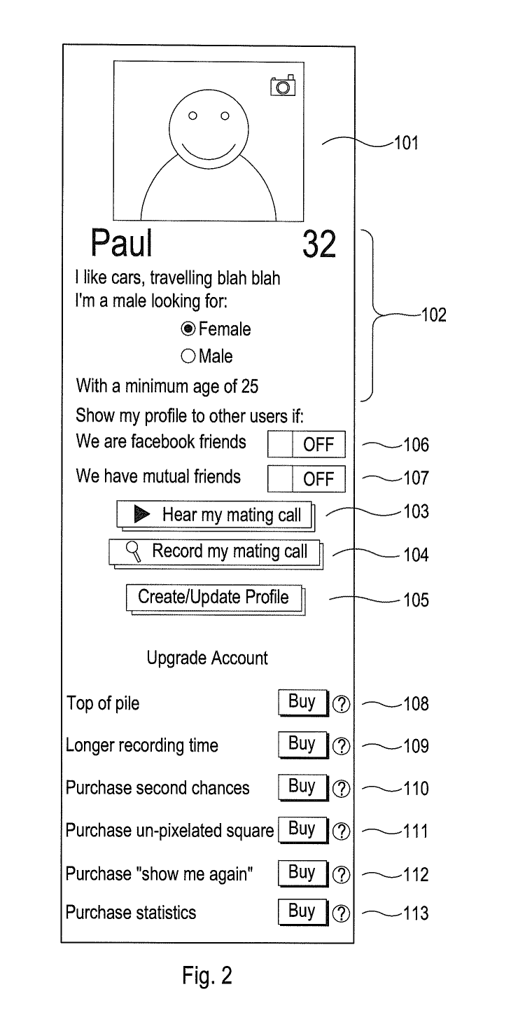

Once the application is launched, the primary user is presented a screen when the app is first loaded, that asks the user to provide social information. Embodiments of the invention allow for a user to sign in to the application using an external social network login 001, for example Facebook™. If this option is utilised, once the user has granted various permissions into Facebook for the app they will be asked to create a profile. FIG. 2 provides a further input screen that allows the provision and selection of relevant profile information to create a primary profile. If the user has opted to import profile information from an existing social network, this information can be used to prepopulate fields of the profile relevant information. Alternatively, a user may provide or override the information as necessary.

In the example shown, the profile will contain the users first name, age, gender, which gender(s) and the minimum age of others users that they are seeking to match with 102. This information is defined herein as search preference information and additional primary user information. Additionally, a profile picture 101 is provided as additional primary user information. As noted above, the profile picture may be selected from an existing social media account, or may be uploaded specifically for this application.

Furthermore, if integrated with an existing social media application, the present application will search through the users uploaded profile pictures and suggest one or more or preferably four images to act as a profile picture on the present application.

The photos the application selects as suggestions are the preferably the users current Facebook profile picture and the three most liked photos from their profile picture album. The user has to choose only one, and any profile picture chosen will be pixelated by the software contained within the app.

Once the profile picture has been selected the user must record audio information defined as an audio/video recording 103, 104. If the video option has been enabled on the server then the user may record a video profile instead of using the voice/picture combination. This video will be pixelated as explained below. The profile screen allows a user to record an audio extract 104. The length of recording is preferably around 20 seconds but may also be around 10 seconds, 15 seconds, 25 seconds, 30 seconds, 35 seconds, 40 seconds, 45 seconds, 50 seconds, 55 seconds or 60 seconds. The length of recording available to a user may be dependent upon activation of premium features or other considerations such as length of time a member that a profile has been active or other relevant considerations. The audio information is added to the primary profile.

Once this information is provided, the user can now create a user or primary profile that will be persisted to a server and database 105. The search preference information, location preference information, ranking preference information and additional primary user information are stored together with the audio information. The database contains the profile information of additional one or more secondary users.

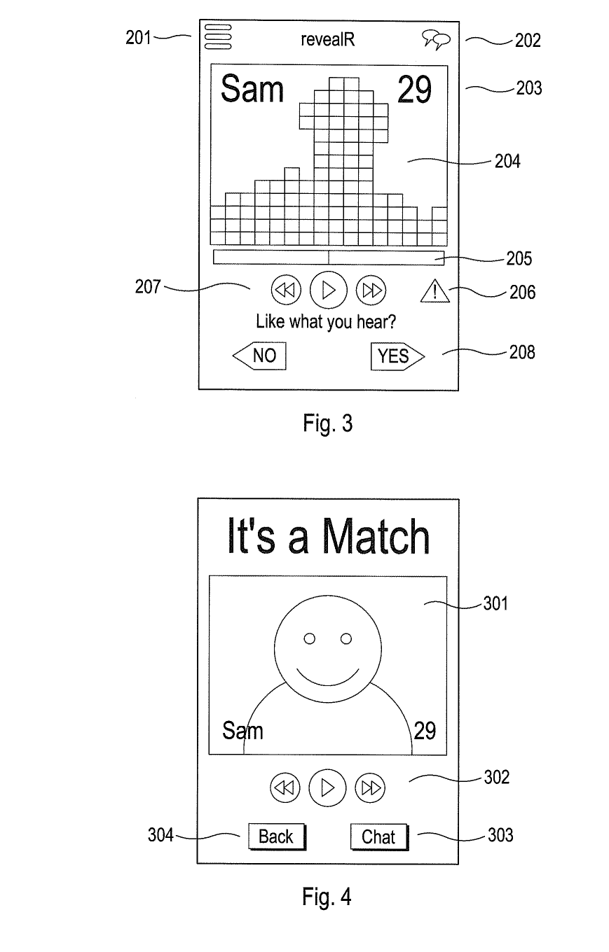

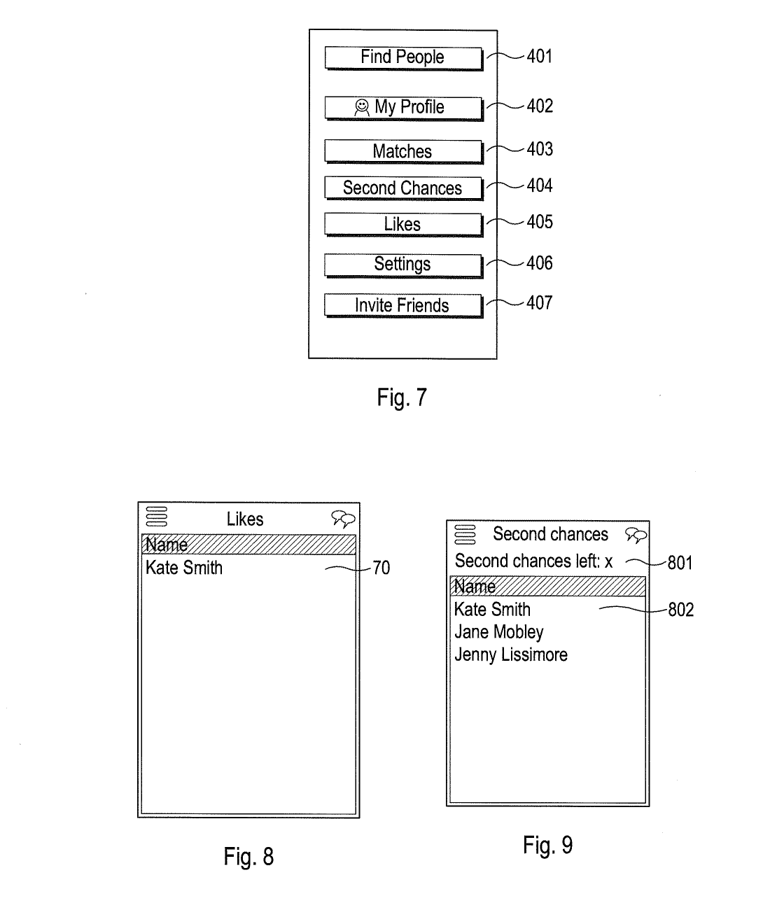

The option to proceed, may be unavailable until minimum profile information has been provided. The user can change this information at any time while using the app via a hand navigation menu (accessed via item 201—see FIG. 3) and selected from the menu list (see FIG. 7).

The profile screen also includes a settings menu that allows the user to modify settings from their default values that were set when the app was first loaded. For example, the settings include the minimum age to search for, the gender(s) they are searching for 102, if they wish to be displayed to other users they are Facebook friends with 106, if they wish to be displayed to other users if they have mutual Facebook friends 107 and the various in-app purchase options (items 108, 109, 110). The in-app purchase options allow a user to unlock premium features. Accordingly, certain features may be unavailable to a user. The individual features will be described in greater detail below.

Each time the user opens the app the system determines their geo location via the device's GPS unit and will contact the server to search for other secondary or secondary users meeting the search criteria. Other location determining mechanisms may include WIFI or cell information from a mobile telephonic network. A combination of location determining sources may be used to ensure an accurate location is determined.

The following search algorithm is proposed in an effort to increase the probability of a match, P(match), between two users whilst reducing the compute power and bandwidth from client to server. The search criteria is as follows:

age>=min search age

whether the secondary profile has previously been viewed by the primary

whether the secondary users profile is active (the account is still active and hasn't been reported>=3 times)

whether the secondary profiles gender matches the gender that the primary user has selected

whether the secondary profile is interested in the gender of the primary user

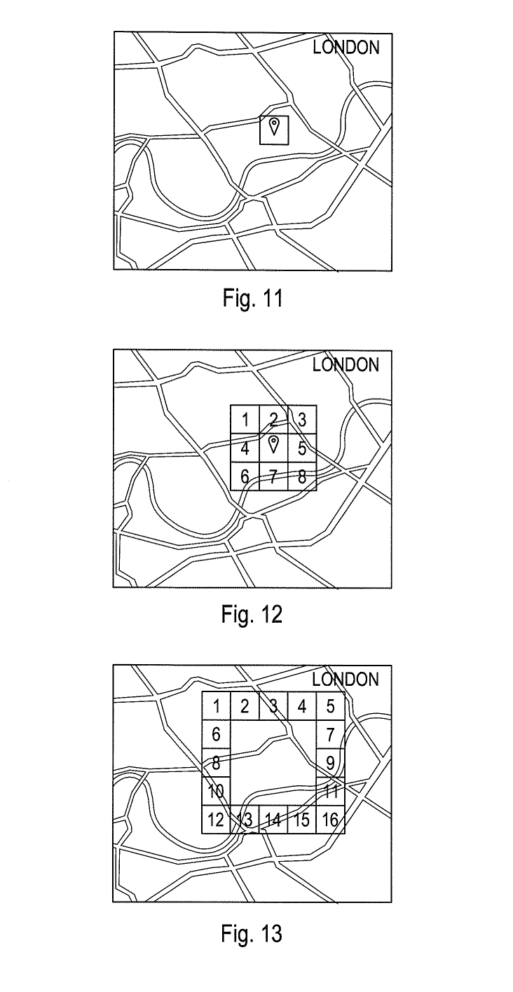

The search algorithm will search for secondary users that are in close proximity to the primary user with the resulting array sorted in ascending distance with secondary users that have already indicated they like the primary user at the start of the array. The distance is determined according to a haversine function from the ranked profiles obtained using Geohash protocols as described below with reference to FIGS. 11 to 13.

The user (defined herein as the “primary”) will be presented with a “secondary” users profile 200 that has been downloaded by the app from the server (via the search algorithm). The secondary users profiles can be ranked according to the ranking and search preference information provided by the primary user. For example, a threshold distance may be chosen to ensure only secondary users within a certain distance from the primary user are displayed. Other ranking preference information includes profile information such as hobbies, interests, likes, mutual friends etc.

The ranked and sifted secondary users define a local pool of N secondary users. Within the local pool of secondary users the secondary users are ranked according to the ranking preference information. The app has a profile cache to enable a smooth and fast experience for the user. The App will search for 20 profiles using the search criteria via the search algorithm and place them in memory so they are available to the user immediately. Once the cache goes below a count of 15 users the app will request another 5 profiles from the server. Once the new profiles have been downloaded to the app, they will be sorted via steps 9, 10, 11 and 12 in the Search Algorithm section.

This cache enables the user to experience the app even when there might not be a data connection available. Other cache sizes may also be selected depending upon the optimum bandwidth requirements of the application and user device.

Once ranked, the highest ranked secondary user is selected and their profile displayed as shown in FIG. 3. Information included in the secondary user profile includes the secondary users pixelated profile picture/video 204, their first name, age 203 and will automatically play the voice recording to the primary or primary user 207. The primary user can also report (item 206) a secondary profile (if they think it's offensive or violates the applications Terms and Conditions). If the profile has been reported by three individuals the user who has been reported will have to re-create their profile in order to comply with the T&C's the next time they use the app and they will also not be shown to other users until they have re-created their profile.

Based solely on the information provided in the screen of FIG. 3, the primary user is queried and required to select if they like the profile or not (a positive or negative profile response) 208. The primary users decision is then persisted to the database and stored as into the database cross-referenced with the relevant selected secondary user profile.

If a positive profile response is obtained, the database is queried to determine whether there exists an existing positive profile response from the secondary user to the primary user. If such a mutual positive profile response is present, a mutual match is obtained. Once the user has either dismissed a secondary user or liked/matched the secondary user a new secondary profile will be presented to the user based on the ranking.

A specific mutual match or mutual like screen may then be displayed to the primary user. This is shown in FIG. 4. Additionally an indication of a mutual match may be sent to the secondary user. This may take the form of a push notification or other information communication method.

The mutual match screen displays the matched secondary users name, age, distance from the primary user and the actual (pixelated) photo or a pixelated still from the recorded video 301. The mutual match screen additionally allows the audio information to be played back 302 and allows a chat request to be sent to the matching secondary user 303. A back button 304 is also provided that returns to the earlier match screen.

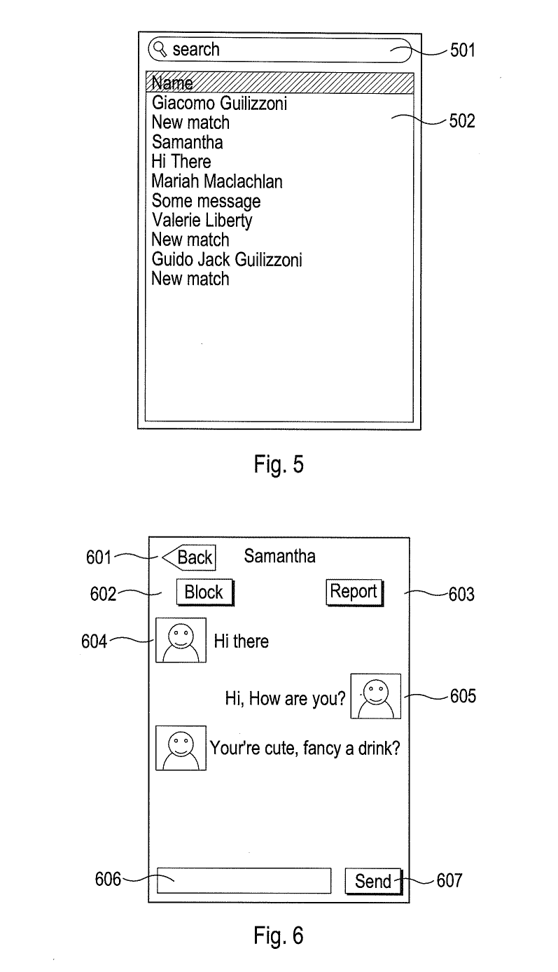

Once a mutual match is obtained, the mutual match is then shown in each and both the primary and secondary users matches screen shown in FIG. 5. The matches screen allows the user to search 501 for mutual matches in a listing 502. The matches screen is accessed through the right hand menu (202 of FIG. 3). Selecting a mutual match from the listing directs the user to the mutual match screen of FIG. 4. From this screen, a chat may be initiated, which allows the two users to chat via instant messenger functionality as shown in FIG. 6. Email or other communication protocols, such as voice protocols, video conferencing protocols (Skype™ or Facetime™) may also be used. The messaging functionality may include the option to block a user 602, report a user 603 and exit the messaging 601. The messenger functionality may also include the profile picture 604 of the primary user and the secondary user 605. A text box 606 allows for entry of standard messaging characters, including audio/visual information, which may be sent using a send button 607.

The application also includes a top level menu as shown in FIG. 7. FIG. 7 presents the user with a series of selection options that allow access to functionality of the application. The find people 401 button initiates the process described above with respect to FIGS. 3 to 6. The my profile button allows the user to access their user profile as shown in FIG. 2.

A second chances feature and button 402 is shown in FIG. 9 and displays 802 the last five profiles that the user has dismissed. This allows the primary user to revisit the dismissed secondary user profiles and remake the decision as to whether they like the profile or not. The second chances feature may be limited to a certain number of uses 801 per day or may be dependent upon the purchase of credits or a premium user token.

The user can also see a list of secondary users (ones they haven't already seen) that have liked the primary users profile 405. From this list (FIG. 8) the user can quickly look at secondary users profile (if they haven't already viewed this secondary profile) by tapping on the profiles name (item 701).

Other premium or standard features may include the ability to purchase an “un-pixelated square” feature (item 111). This allows the user to select an area of their pixelated photo/video to be un-pixelated (area of the un-pixelated square<<area of the pixelated picture/video). This allows the user to show other others a feature of their profile picture/video they feel will increase the probability of a match based on their enhanced profile.

If the user has purchased the “Show Statistics” option (item 113) then the user will be presented with a screen that displays the following statistics that can be reset by the user at any time:

Number of profile views

Percentage of likes and declines

Percentage of match's relative to the number of likes

How the user compare to other users

Demographic analysis of the users they appeal to most

There are various additional application options that allows the user to do the following:

Upgrade their account to put their profile at the top of search in front of other users 108

Upgrade account so that they record their voice/video profile for longer than the default 20 seconds 109

Purchase more “second chances” to enable them to see the previously dismissed users, for a second chance of mutual match's 110, 404 and FIG. 9

Upgrade account to see which users have liked your profile 405 and FIG. 8

Pay for a square area on the pixelated photo/video to be un-pixelated 111

The “Show Me Again” feature allows users to pay in order to reset the database for the user so that they get shown to users they have previously been shown to and they have been declined by the primary user 112

Pay for “Statistics” 113 that displays various statistics to the user in order for them to determine the best profile combination that yields the most match's.

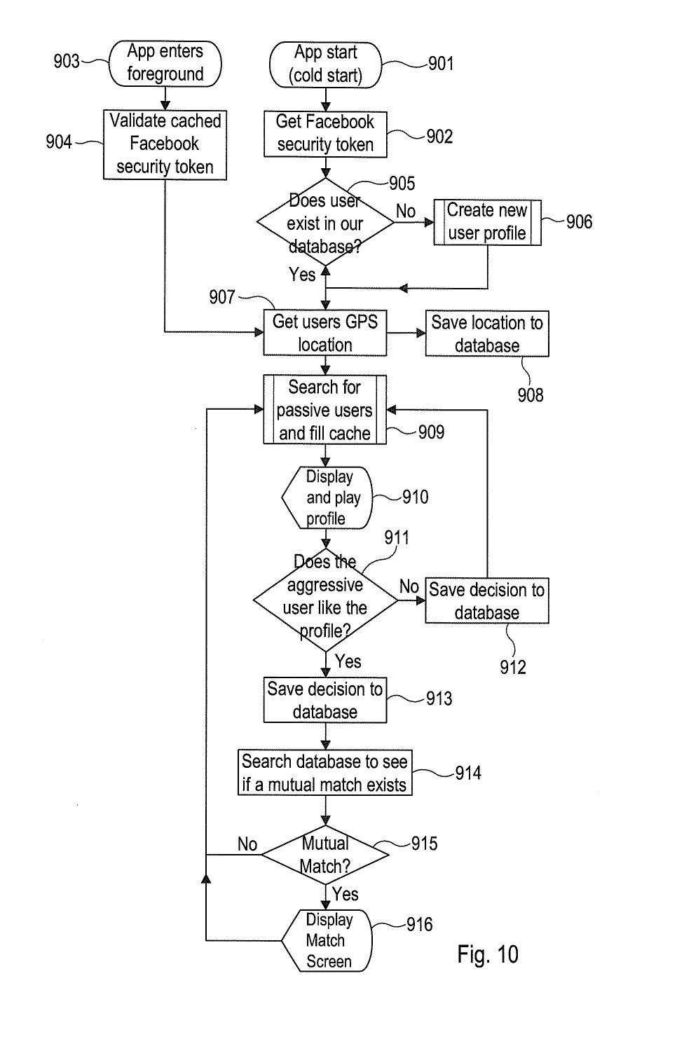

FIG. 10 outliners the broad procedure of the application. Initially the app is launched 901 and attempts to obtain a security token from an existing social networking site such as Facebook™ 902. If the application has previously been allowed to enter a sleep mode and is then returned to the foreground 903, a similar validation token is requested 904. On application cold start, once a valid security token is obtained, the user information embedded within the token is compared against the application database 905. If the user is not already registered and thus does not have a stored profile information on the database then a new profile 906 is created for the user.

Once the profile is created, or after an existing profile is verified, the users current geostationary positioning signal location is queried and obtained 907. Providing the current location is obtainable, this information is saved to the primary users profile information and relayed and updated in the database 908.

Once the users current location is known (or alternatively selected by the user), a search 909 is initiated for passive or secondary users fulfilling previously determined criteria.

The number of secondary users that fulfil the criteria are stored within a local pool of secondary users and stored to a cache on the primary users device.

The highest ranked secondary user is then selected and their profile displayed to the primary user, including playing the audio information contained within the selected secondary users profile 910.

The primary or aggressive/aggressor user is then queried to determine whether they like the selected secondary users profile 911. If a negative profile response is returned, the decision is saved in the database 912 against the cross referenced record of the primary and secondary user (akin to a matrix). As noted above, the selected secondary user is then removed from the local pool of users and the next highest ranked secondary users profile displayed to the primary user. The cache and search may be updated accordingly.

If the primary user returns a positive profile response, the decision is saved to the database 913 as per above. The database then undertakes a search 914 to ascertain if the selected secondary user has also returned a positive profile response against the primary user (a mutual match). If a mutual match 915 is determined, a match screen is displayed 916. If no mutual match exists, the selected secondary user is removed from the local pool of secondary users and the next ranked secondary users profile is displayed to the primary user. An additional search or cache update may also be performed.

The methodology for determining the secondary users within a predetermined distance of the primary user is calculated as follows.

Calculate Geohash, g=geohash(lat·lon), for latitude and longitude of primary user U, at precision 12

Find secondary profiles with the same GeoHash at precision p (p<12) (see FIG. 11) meeting the search criteria

If count of secondary profiles, Σu from step 2 is <N then create a random neighbour Geohash from within a 3×3 grid minus the central 1×1 grid as per FIG. 12, and take random sample of secondary profiles from the new grid (see FIG. 12)

If count of secondary profiles, Σu, from step 3 is <N then create another random neighbour Geohash, different from the previous, from within the 9×9 grid minus the central 1×1 grid as per FIG. 2, and take random sample of secondary profiles from the new grid (see FIG. 12)

Repeat step 4 until all of the 9 grid elements have been searched. If the total count of secondary profiles, Σu, found from step 3 is <N then increase grid size to 5×5 (minus the 3×3 grid already searched), and take random sample of secondary profiles from the grid (see FIG. 13)

If count from the grid is <N then increase grid to 7×7, negative the 5×5 set

If count from the grid is <N then decrease the precision and repeat from step 2.

If count from country is <N then take a random sample from the entire database of secondary profiles

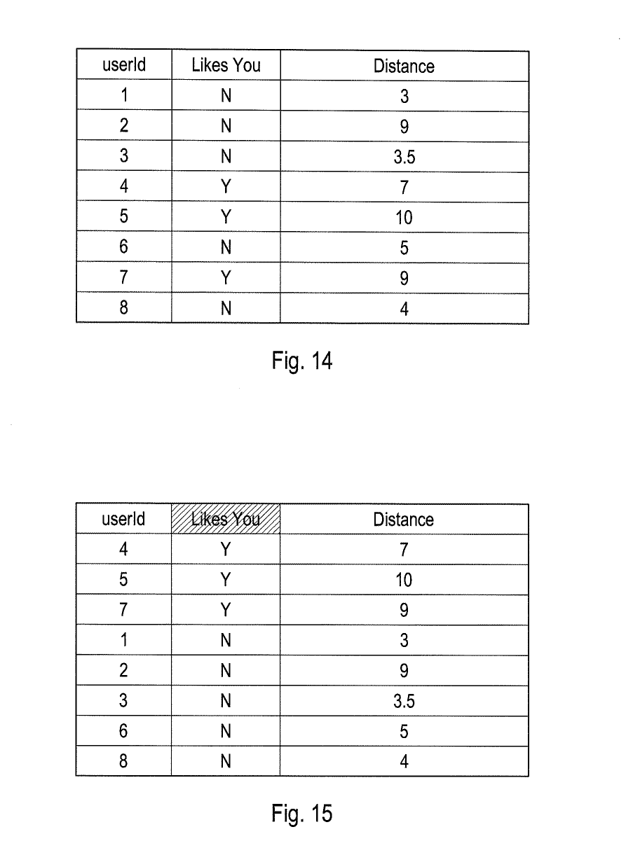

Once N profiles have been found from the database and placed in an array, A, compute the distance between each secondary profile and the primary profile using the haversine formula, as per FIG. 14.

Sort the array so that if the secondary user in the array has already indicated they want to match with the primary user they will be placed at the top of the array, as per FIG. 15

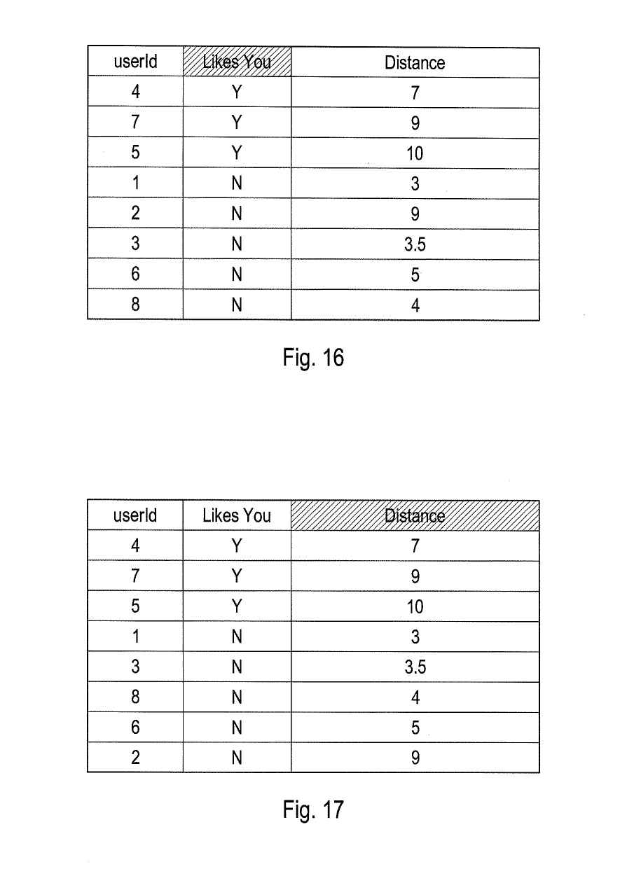

Sort the array concentrating only on elements that have a match flag set to Y, and sort those elements in ascending distance, as per FIG. 16

Sort the array concentrating only on elements that have a match flag set to N, and sort those elements in ascending distance, as per FIG. 17

To find secondary profiles matching the Geohash grid element at precision p from the database the search criteria is as follows:

LEFT(Geohash, p)=Grid Element Geohash

The haversine formula for distance d, is as follows, where r is the earths radius:

$$d = 2 r arcsin ( \sqrt{{sin}^{2} ( \frac{{φ}_{2} - {φ}_{1}}{2} ) + cos ( {φ}_{1} ) cos ( {φ}_{2} ) {sin}^{2} ( \frac{{λ}_{2} - {λ}_{1}}{2} )} )$$

In some configurations, the apparatus or system includes means for performing various functions as described herein. In one example, the means may be a module including a processor or processors and associated memory in which embodiments of the disclosure reside, such as are shown in the preceding drawings and which are configured to perform the functions recited by the means. The means may be, for example, modules or apparatus residing in client devices, host server systems, and/or other network devices such as are shown and/or described herein. In another example, the aforementioned means may be a module or apparatus configured to perform the functions recited by the aforementioned means.

In one or more exemplary embodiments, the functions, methods and processes described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, computer program products comprising computer-readable media including all forms of computer-readable medium except, to the extent that such media is deemed to be non-statutory, transitory propagating signals.

To aid the Patent Office, and any readers of any patent issued on this application in interpreting the claims appended hereto, applicants wish to note that they do not intend any of the appended claims or claim elements to invoke paragraph 6 of 35 U.S.C. Section 112 as it exists on the date of filing hereof unless the words “means for” or “step for” are explicitly used in the particular claim.

1. A method for facilitating location based social interaction, said method comprising the steps of:
i) requesting a search criteria based on a primary user profile of a primary user;
ii) searching for N secondary users conforming to the search criteria; and
iii) transmitting secondary user profiles of the N secondary users to a primary user device; wherein each secondary user profile contains personalised audio information relevant to the secondary user.

2. A method according to claim 1, further comprising the step of: obtaining a location for the primary user of the primary user device.

3. A method according to claim 2, wherein the N secondary users are selected based at least on the range of the secondary user from the primary user.

4. A method according claim 1, wherein the N secondary users are selected based on the search criteria of the primary user and the search criteria of the secondary user.

5. A method according to claim 4, wherein the search criteria comprises analysing one or more search flags, said search flags including one or more of whether:
the secondary user profile has been previously viewed by the primary user;
ranking flags are activated in the secondary/primary user profile;
there is overlapping preference information in the secondary user profile and the primary user profile;
the ages of the secondary and primary users are within identified ranges;
the primary user profile has previously been viewed by the secondary user;
the secondary users profile is active;
the gender of the secondary user matches a gender that the primary user has selected; and
the secondary user is interested in the selected gender of the primary user.

6. A method according to claim 5, wherein the ranking flags include a preferential ranking flag.

7. A method according to claim 5, wherein the search flags identifying whether the secondary user profile has previously been viewed by the primary user are overridden by a reset flag stored on the primary user profile; or
wherein the search flags identifying whether the secondary user profile has previously been viewed by the primary user are overridden by a reset flag stored on the secondary user profile.

8. A method according to claim 7, wherein the reset flag is a variable stored in the primary user profile.

9. A method according to claim 7, wherein the reset flag is a variable stored in the secondary user profile.

10. A method according to claim 1, wherein the secondary user profiles contain pixelated visual information.

11. A method according to claim 10, wherein the visual information is pixelated on the primary user device.

12. A method according to claim 10, wherein the visual information is selectively pixelated.

13. A system for handling location based social matching, the system comprising:
a server comprising:
a processor;
processor readable memory; and
a database comprising:
a plurality of profiles associated with an equal number of plurality of users, including audio information assigned and distinguishing each user;
location indicators associated with each profile; and
cross-referenced profile responses between the plurality of users.

14. A system according to claim 13; said system further comprising:
a primary user device, said primary user device comprising:
a device receiver for receiving information and a device transmitter for transmitting information; and
a device memory containing a primary profile of a primary user containing stored search preference information; and
a receiver for receiving information from, and a transmitter for transmitting information to, the primary user device;
wherein the system is configured to receive the primary profile from the primary user device, sift the plurality of profiles based on the search preference information to select one or more secondary user profiles from the plurality of profiles and transmit said one or more secondary user profiles to the primary user.

15. A system according to claim 14, further comprising:
a user interface on the primary user device allowing the primary user to indicate a positive or negative response to the audio information contained in the one or more secondary user profiles,
wherein the primary user device is configured to transmit the positive or negative responses to the database and wherein the database is configured to receive and store the positive or negative profile response of the primary user against each respective secondary user profile.

16. A method comprising the step of providing a system according to claim 15.

17. A method according to claim 16, wherein when a positive profile response is received and stored, the method further includes the steps of:
querying the database to determine if a mutual match exists.

18. The method of claim 17, wherein a mutual match exists if the primary user has indicated a positive profile response to the secondary user profile and a secondary user assigned to the secondary user profile has indicated a positive profile response to the primary user.

19. The method of claim 17, wherein the step of querying the database to determine if a mutual match exists includes searching the database for profile responses of the selected secondary user profile to determine whether a stored profile response is assigned with the primary user and if a stored profile response is present.

20. The method of claim 17, wherein if the stored profile response of the secondary user and the stored profile response of the primary user are both positive, a mutual match is indicated to the primary user.

21. The method of claim 20, wherein the mutual match is indicated to the secondary user.

22. The method of claim 17 wherein if a negative profile response is obtained, the selected secondary user is removed from a local pool of users and an alternative secondary user is presented to the primary user.

23. The method of claim 17, wherein if a mutual match is not present, the positive query response is stored in the database and aligned against the selected secondary user.

24. The method of claim 17, wherein if the stored profile response of the selected secondary user is positive, further comprising the step of relaying this information to the primary user.

25. The method of claim 17, wherein the step of searching for one or more secondary users includes the steps of:
querying a user database to establish a local pool of secondary users;
sifting the local pool of secondary users based on at least one of the search preference information and additional primary user information

26. The method of claim 25, wherein if a negative profile response is obtained, further comprising the step of
relaying this information to the primary user and allowing the primary user to reinstate the selected secondary user to the local pool of users.

27. The method of claim 17, wherein the primary and secondary profiles contain pixelated visual information.

28. The method of claim 17, wherein the method further comprises the step of:
when a mutual match exists, displaying the secondary profile to the primary user.

29. The method of claim 17, wherein selecting a secondary user includes the steps of:
downloading a local pool of users containing one or more secondary user profiles to the primary user device; and
storing the one or more secondary user profiles to the primary user device.
